(19) United States
(12) Patent Application Publication
(10) Pub. No.: US 2010/0051755 A1
(43) Pub. Date: Mar. 4, 2010

(54) TAIL-LESS BOXED BIPLANE AIR VEHICLE

(75) Inventors: David C. Nichols, Fredericksburg, VA (US); Robert Nichols, Ann Arbor, MI (US)

Correspondence Address: VENABLE LLP, P.O. BOX 34385, WASHINGTON, DC, 20043-9998, US

(73) Assignee: DarkStar LLC, Fredericksburg, VA (US)

(21) Appl. No.: 12/198,340

(22) Filed: Aug. 26, 2008

(51) Int. Cl. B64C 39/08; B64C 11/00; G05D 1/00; B64C 25/00

(52) U.S. Cl. 244/45 R; 244/62; 701/2; 244/100 R

(57) ABSTRACT

An exemplary embodiment of the present invention sets forth an exemplary bi-plane air vehicle. The air vehicle may include, a plurality of wings coupled to one another in substantially a box configuration, wherein the bi-plane air vehicle has no tail.

### FIELD OF THE INVENTION

The present invention relates generally to aircraft, and more specifically, to biplanes.

### BACKGROUND OF INVENTION

Biplane aircraft, such as, e.g., a fixed-wing aircraft or air vehicle with two main wings, are well known in the art. A typical biplane aircraft is usually configured such that the lower wing is located below, and attached to, a fuselage. The upper wing is then positioned over the lower wing. The upper wing is attached to the lower wing via a series of tension members (typically wires) and compression members (typically struts). The upper and lower wings may include flaps or ailerons. The typical biplane aircraft also conventionally includes a tail, to control the pitch, or angle of attack of the aircraft.

### SUMMARY OF THE INVENTION

An exemplary embodiment of the present invention sets forth an exemplary bi-plane air vehicle. The air vehicle may include, a plurality of wings coupled to one another in substantially a box configuration, wherein the bi-plane air vehicle has no tail.

According to one exemplary embodiment, the air vehicle may further include at least one propulsion mechanism disposed on the air vehicle.

According to one exemplary embodiment, the propulsion mechanism may include at least one motor coupled to, and operable to rotate a propeller and at least one power source coupled to the motor to energize the motor.

According to one exemplary embodiment, the propeller is at least one of rearward or forward facing.

According to one exemplary embodiment, the propulsion mechanism may further include a power source. The power source may include at least one of: a hydrogen fuel cell; a fossil fuel; a rechargeable battery; a battery; a fuel cell; a power supply; or a solar cell.

According to one exemplary embodiment, the propulsion mechanism may include at least one of a propeller coupled to a motor; a propeller coupled to a gas motor; a propeller coupled to an electric motor; a propeller coupled to a motor powered by solar energy; a propeller coupled to a motor powered by a hydrogen fuel source; a propeller coupled to a motor powered by a fuel cell; a jet; a turboprop; or a rocket.

According to one exemplary embodiment, the motor is an electric motor.

According to one exemplary embodiment, the motor is an engine.

According to one exemplary embodiment, the air vehicle may be at least one of: a manned air vehicle; an airplane; an unmanned air vehicle (UAV); a mini-UAV; or a micro-UAV.

According to one exemplary embodiment, the air vehicle may be a manned air vehicle.

According to one exemplary embodiment, the plurality of wings may be at least one of: a wing; a delta-wing; a swept wing; a cranked arrow wing; or a straight wing.

According to one exemplary embodiment, a first of the plurality of wings is disposed forward of a second of the plurality of wings.

According to one exemplary embodiment, a first of the plurality of wings has a first wing shape and a second of the plurality of wings may has a second wing shape.

According to one exemplary embodiment, a first of the plurality of wings has a cranked arrow wing shape and a second of the plurality of wings has a delta wing shape.

According to one exemplary embodiment, a first and a second of the plurality of wings have delta wing shapes.

According to one exemplary embodiment, the air vehicle further includes a wireless communication link for remote control of the air vehicle.

According to one exemplary embodiment, the wireless communication link may contain at least one of: an infrared (IR) link; a line-of-sight link; a radio-frequency (RF) communication link; or a laser link.

According to one exemplary embodiment, the air vehicle further includes an assisted take off system.

According to one exemplary embodiment, the air vehicle further includes a landing device.

According to one exemplary embodiment, the air vehicle further includes a payload.

According to one exemplary embodiment, the payload includes a sensor, wherein the sensor comprises at least one: a thermal sensor; an electromagnetic sensor; a mechanical sensor; a chemical sensor; an optical radiation sensor; an ionizing radiation sensor; an acoustic sensor; a positional sensor; or an altitude sensor.

According to one exemplary embodiment, the plurality of wings comprise a pair and wherein a first of the pair of wings extends further in front of a second of the pair of wings.

According to one exemplary embodiment, the air vehicle further includes a middle wing joiner to increase structural strength of the vehicle.

According to one exemplary embodiment, the plurality of wings are constructed from at least one of the following: foam; aluminum; metal; plastic; polymer; or wood.

According to one exemplary embodiment, the plurality of wings are coupled together by at least one wing joiner.

According to one exemplary embodiment, the plurality of wings are coupled together by a pair of wing joiners at the extremities of each wing forming the box configuration, wherein the box configuration comprises substantially orthogonal corners when viewed from at least one of a front, or a back of the air vehicle.

According to one exemplary embodiment, the plurality of wings are coupled together by a pair of wing joiners at the extremities of each wing forming the box configuration, wherein the box configuration comprises rounded corners when viewed from at least one of a front, or a back of the air vehicle.

### BRIEF DESCRIPTION OF THE DRAWINGS

The foregoing and other features of exemplary embodiments described herein will be apparent from the following description as illustrated in the accompanying drawings wherein like reference numbers generally indicate identical, functionally similar, and/or structurally similar elements.

FIGS. 1A, 1B, and 1C depict two exemplary embodiments of the aircraft.

FIGS. 2A-2E depict five exemplary embodiments of the aircraft with five exemplary aspect ratios.

FIG. 3 depicts an exemplary table containing exemplary dimensions for the five exemplary embodiments of FIGS. 2A-2E.

FIG. 4 depicts the lift to drag ratio as a function of aspect ratio for the five exemplary embodiments of FIGS. 2A-2E.

FIGS. 5A-5E depict six exemplary embodiments of the aircraft with six exemplary wing separation amounts.

FIG. 6 depicts the lift to drag ratio as a function of the wing separation amounts for the exemplary embodiments of FIGS. 5A-5E.

FIGS. 7A-7I depict nine exemplary embodiments 701A-701I of the aircraft 10 with nine exemplary wing stagger amounts.

FIG. 8 depicts the lift to drag ratio as a function of wing stagger for the exemplary embodiments of FIGS. 7A-7I.

FIGS. 9A-9E depict five exemplary embodiments of the aircraft with exemplary wing area distributions and an exemplary positive stagger.

FIGS. 10A-10E depict five exemplary embodiments of the aircraft with exemplary wing area distributions and an exemplary negative stagger.

FIG. 11 depicts the lift to drag ratio as a function of the positive or negative wing stagger for the exemplary embodiments of FIGS. 9A-9E and 10A-10E.

FIG. 12 depicts exemplary airfoils.

FIG. 13 depicts exemplary polar curves for the exemplary airfoils of FIG. 12.

FIG. 14 depicts the lift to drag ratio as a function of angle of attack for an exemplary embodiment of the aircraft.

FIG. 15 depicts a global aircraft polar curve.

FIG. 16 depicts an exemplary flight speed as a function of angle of attack for an exemplary embodiment of the aircraft.

FIG. 17 shows an exemplary static determination of an exemplary thrust line for an exemplary embodiment.

### DETAILED DESCRIPTION OF VARIOUS EXEMPLARY EMBODIMENTS OF THE INVENTION

### General Aerodynamic Design

Various exemplary embodiments of the invention are discussed in detail below. In describing embodiments, specific terminology may be employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may. Embodiments of the invention may comprise an aircraft and/or an air vehicle.

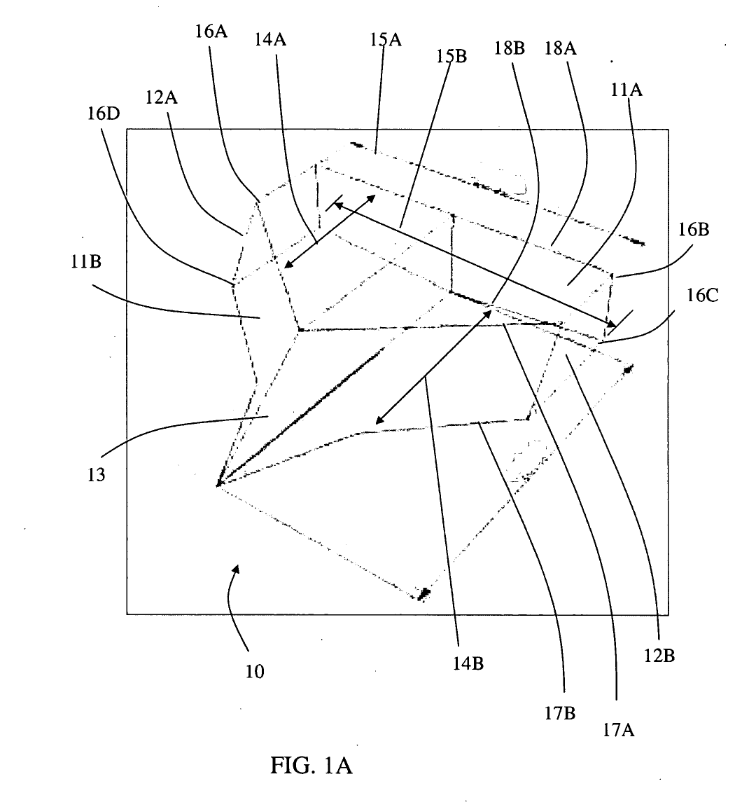

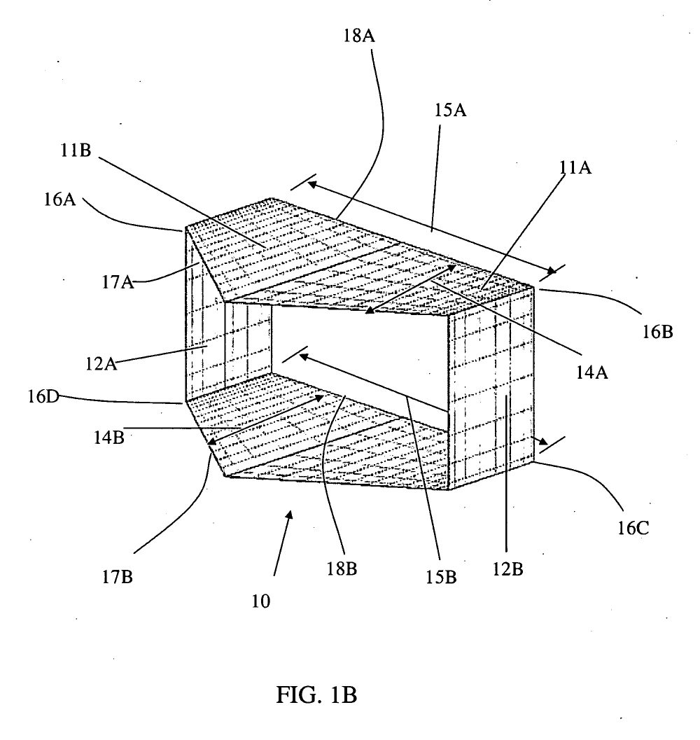

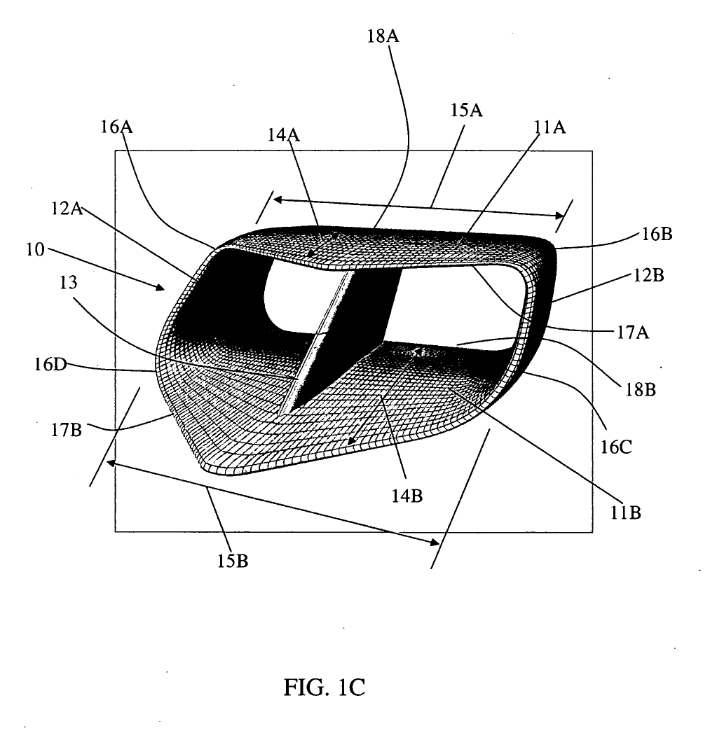

FIGS. 1A, 1B, and 1C depict three exemplary embodiments of exemplary aircraft 10. The aircraft 10 may generally include, e.g., but is not limited to, an exemplary first wing 11A, and an exemplary second wing 11B, arranged in a box configuration with two side wing joiners 12A, 12B (which may also be referred to as end caps), an optional middle wing joiner 13, a propulsion mechanism (not shown), and/or a payload (not shown). In an exemplary embodiment, a box configuration may also include a box-like configuration. For example, the wing joiners may be rounded, etc. The first wing 11A may have a mean aerodynamic chord 14A, a span 15A, a first edge 17A, and a second edge 18A. The second wing 11B may have a mean aerodynamic chord 14B, a span 15B, a first edge 17B, and a second edge 18B.

In an exemplary embodiment, the first wing 11A, second wing 11B, and wing joiners 12A and 12B may be coupled together at corners 16A-16D. In an exemplary embodiment, the first wing 11A, second wing 11B, and wing joiners 12A and 12B may be coupled together at corners 16A-16D orthogonally, or approximately orthogonally, when viewed from a front or a back view, to one another to either form, or approximate, a 90 degree angle. FIGS. 1A and 1B, among others, depict exemplary embodiments of aircraft 10 with orthogonal corners.

In another exemplary embodiment, the first wing 11A, second wing 11B, and wing joiners 12A and 12B may be coupled together at corners 16A-16D such that the corners 16A-16D may be rounded and/or smoothed, when viewed from a front or a back view. FIG. 1C depict an exemplary embodiment of aircraft 10 with rounded corners.

In an exemplary embodiment, either of the first wing 11A and/or the second wing 11B may include wing shapes such as, e.g., but not limited to, a delta wing, a cranked arrow wing, a swept wing, a trapezoid wing, a straight wing, or a conventional wing, etc.

In an exemplary embodiment of the aircraft 10, the first wing 11A may be the same or similar wing shape as the second wing 11B. For example, FIG. 1B depicts an aircraft 10 with two delta wings 11A and 11B.

In an exemplary embodiment of the aircraft 10, the first wing 11A may be of a different wing shape than the second wing 11B. For example, FIGS. 1A and 1C depict an aircraft 10 with a delta wing 11A and a cranked arrow wing 11B.

In an exemplary embodiment, one or both of the first wing 11A and the second wing 11B may be oriented such that, e.g., but not limited to, any of edges 17A, 18A, or 17B, 18B may be oriented as the leading edge of wings 11A and/or 11B, respectively.

The exemplary aircraft 10 may be constructed out of a variety of resilient material including, e.g., but not limited to, foam, plastic, metal, polymer, and/or wood, etc.

The exemplary aircraft 10 may be constructed in a variety of sizes capable of carrying cargo and/or personnel. Exemplary embodiments of the aircraft 10 may include, e.g., but are not limited to, an airplane, an unmanned air vehicle (UAV), a mini-UAV, or a micro-UAV.

Exemplary embodiments of the aircraft 10 may be piloted via, e.g., but not limited to, an automated onboard system, an onboard pilot, and/or a wireless communication link. The wireless communication link may be comprised of, e.g., but not limited to, a radio-frequency link, an infrared (IR) link, a line-of-sight link, and/or a laser link.

Exemplary embodiments of the aircraft 10 may rely, partially or completely, on gravity and/or rising air to generate lift. In an exemplary embodiment, the aircraft may be a glider.

Exemplary embodiments of the aircraft 10 may contain a variety of propulsion mechanisms, described further below.

Exemplary embodiments of the aircraft 10 may take off and/or land using a variety of conventional methods. An exemplary aircraft 10 may take off via e.g., but not limited to, onboard devices including, e.g., but not limited to, wheels, skis, floats, and/or skids, or external devices including, e.g., but not limited to, an assisted take off system such as a launcher, an aircraft catapult, a jet engine, a rocket, another aircraft and/or by being thrown by a person. An exemplary aircraft 10 may land via, e.g., but not limited to, onboard devices including, e.g., but not limited to, wheels, skis, floats , and/or skids, or external devices including, e.g., but not limited to, a net, arresting gear, foam, dirt, mud, and/or gravel

### Aspect Ratio

According to various exemplary embodiments, the aircraft may have one of several aspect ratios. The aircraft's aspect ratio may refer to the ratio of the aircraft's span versus the aircraft's height. The aircraft's height may refer to the average of the first wing span and the second wing span. An aircraft's aspect ratio may impact an exemplary aircraft's efficiency and/or flying characteristics.

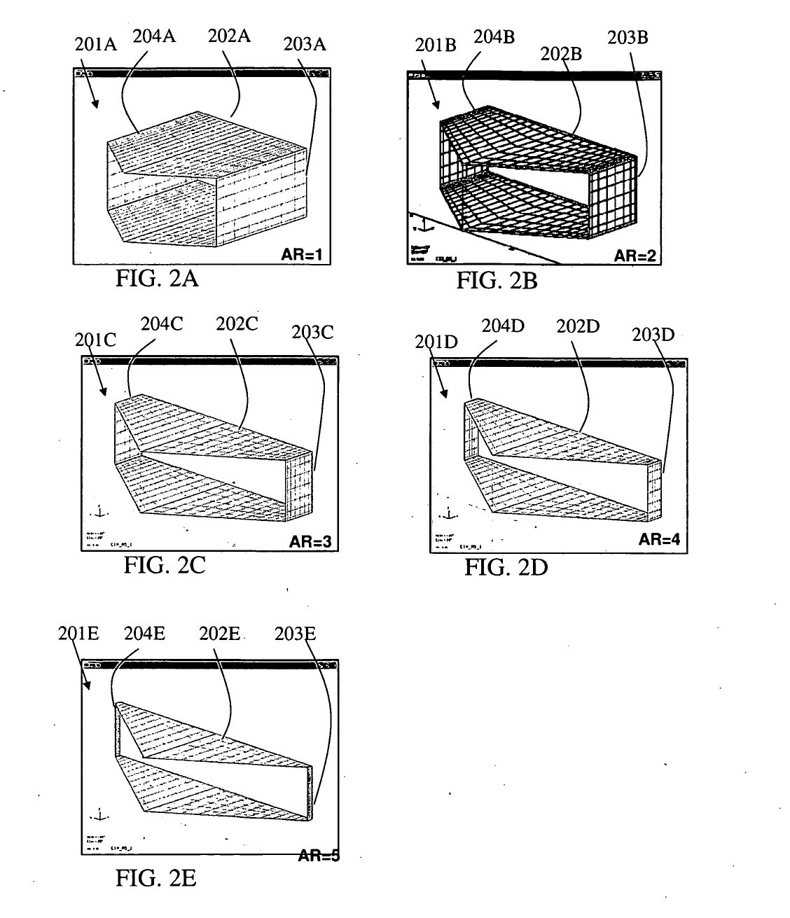

FIGS. 2A-2E depict five exemplary embodiments 201A-201E of the aircraft 10 with five different exemplary, but not limiting, aspect ratios ranging from 1:1 to 5:1. Exemplary embodiments 201A-201E may have, e.g., but not limited to, equal wing areas, no stagger, a constant wing area, and/or a wing sweep angle of 35°.

FIG. 2A depicts an exemplary embodiment 201A with an exemplary aspect ratio of 1:1, a span 202A, a height 203A, and a cord 204A. According to an exemplary embodiment, span 202A may be approximately equal to height 203A.

FIG. 2B depicts an exemplary embodiment 201B with an aspect ratio of 2:1, a span 202B, a height 203B, and a cord 204B. According to an exemplary embodiment, span 202B may be twice as long as height 203B is high.

FIG. 2C depicts exemplary embodiment 201C with an aspect ratio of 3:1, a span 202C, a height 203C, and a cord 204C. According to an exemplary embodiment, span 202C may be three times as long as height 203C is high.

FIG. 2D depicts exemplary embodiment 201D with an aspect ratio of 4:1, a span 202D, a height 203D, and a cord 204D. According to an exemplary embodiment, span 202D may be four times as long as height 203D is high.

FIG. 2E depicts exemplary embodiment 201D with an aspect ratio of 5:1, a span 202D, a height 203D, and a cord 204D. According to an exemplary embodiment, span 202D may be five times as long as height 203D is high.

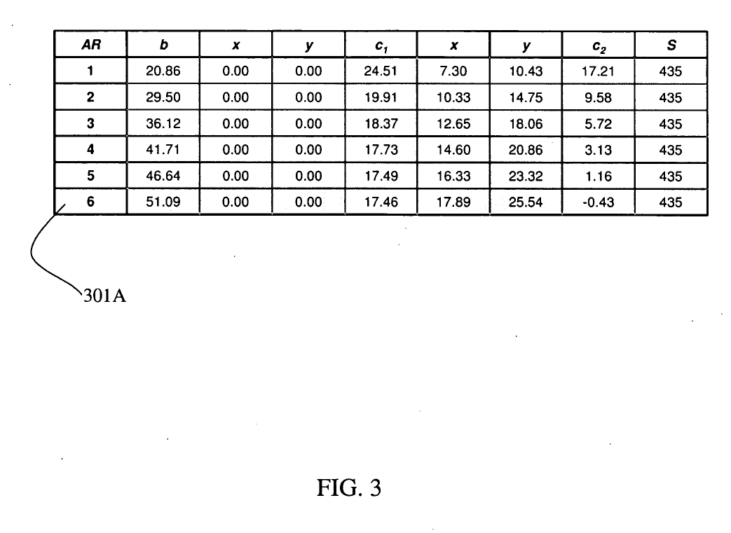

FIG. 3 depicts an exemplary table containing exemplary dimensions for five exemplary embodiments 101A-101E of the aircraft 10 where the total wing area was set to, e.g., but not limited to, 870 in², or 435 in² per wing, and a wing sweep angle was set to 35°. FIG. 3 also depicts exemplary dimensions for an exemplary embodiment with an exemplary aspect ratio of 6:1 301A. According to an exemplary embodiment, given the above assumptions, an aircraft with an aspect ratio of 6:1 would have a negative cord length at the wing tips. Thus, given the above assumptions, an exemplary embodiment may not have an aspect ratio of more than 5.7.

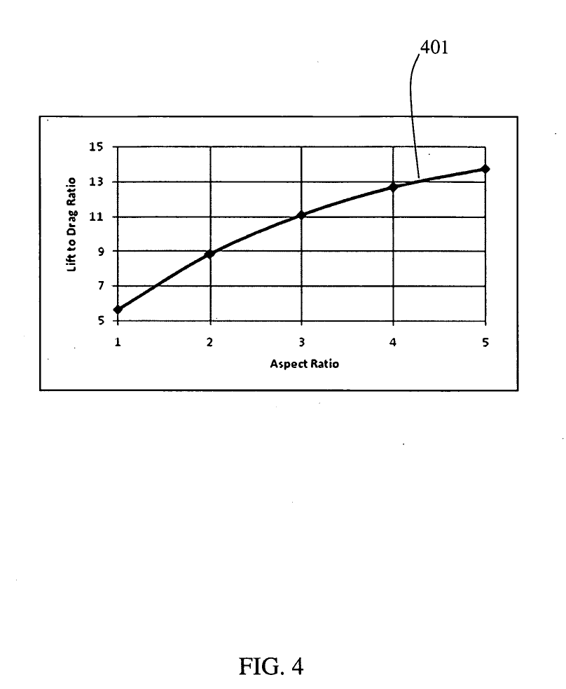

FIG. 4 depicts the lift to drag ratio as a function of an exemplary aspect ratio for exemplary embodiments 101A-101E. Using Augment Vortex Lattice method code (‘AVL’), the lift to drag ratio may be plotted for each exemplary embodiment 101A-101E using a total wing area of 435 in² per wing, a wing sweep angle of 35°, an angle of attack of 2°, and a coefficient profile drag of 0.0069. Once each of the five lift to drag ratios is determined, they may be plotted and a best-fit trend line 401 may be inserted. As the best-fit trend line 401 illustrates, as the aspect ratio increases, the lift to drag ratio may increase logarithmically. The actual lift to drag ratio of an aircraft may depend on, among other factors, the aircraft's actual coefficient of drag which may depend on, e.g., but not limited to, skin friction.

An exemplary vehicle's aspect ratio may be selected to meet a variety of design criteria. For example, in order to produce a durable aircraft, an exemplary embodiment may set the aspect ratio to 3. An aspect ratio of 3 may allow for two side wing joiners to be sufficiently large and thereby supply adequate structural support for the aircraft.

### Wing Separation

According to some exemplary embodiments, an aircraft's wings may be separated. Separating an aircraft's wings may impact the aircraft's efficiency and/or flying characteristics.

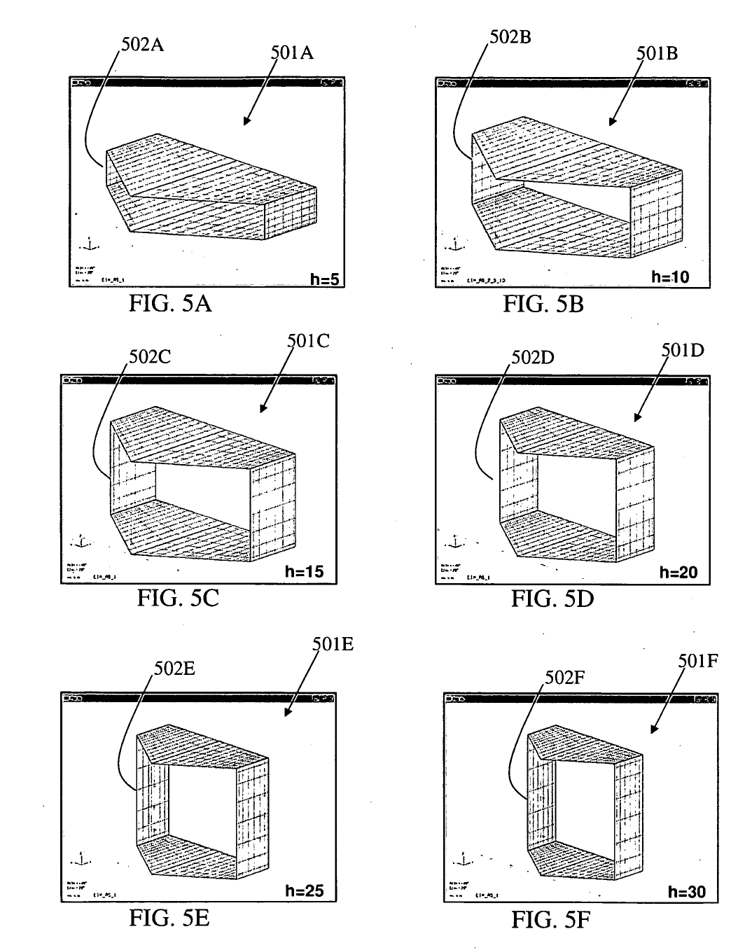

FIGS. 5A-5F depict six exemplary embodiments 501A-501F of the aircraft 10 with an exemplary six different wing separation amounts. Exemplary embodiment 501A-501F may have equal wing areas, no wing stagger, and a constant aspect ratio.

FIG. 5A depicts an exemplary embodiment 501A with a wing separation 502A equal to 5 inches.

FIG. 5B depicts an exemplary embodiment 501B with a wing separation 502A equal to 10 inches.

FIG. 5C depicts an exemplary embodiment 501C with a wing separation 502C equal to 15 inches.

FIG. 5D depicts an exemplary embodiment 501D with a wing separation 502D equal to 20 inches.

FIG. 5E depicts an exemplary embodiment 501E with a wing separation 502E equal to 25 inches.

FIG. 5F depicts an exemplary embodiment 501F with a wing separation 502F equal to 30 inches.

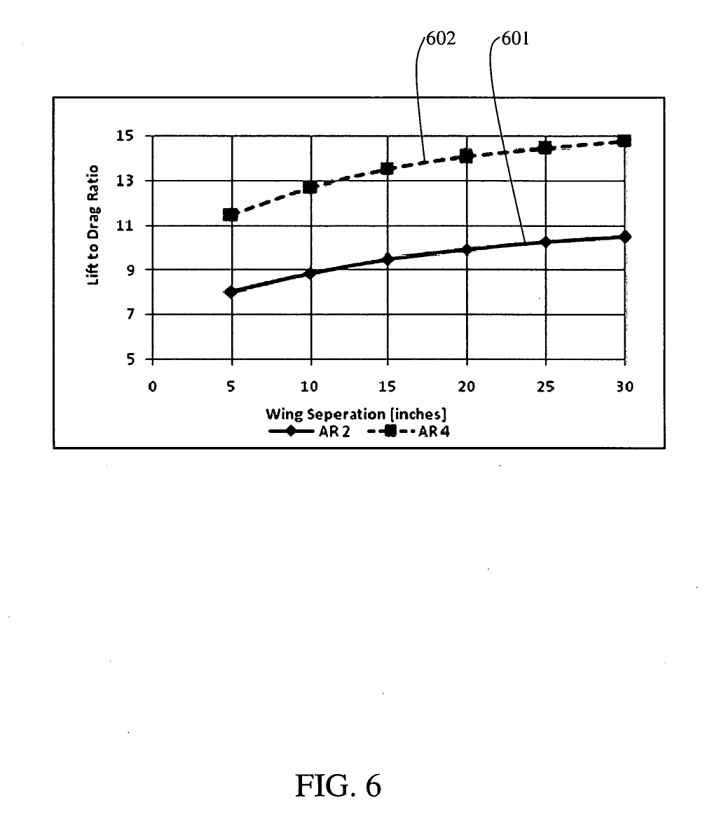

FIG. 6 depicts the lift to drag ratio as a function of the wing separation amount for the exemplary embodiments 501A-501F. Using AVL, the lift to drag ratio may be plotted for each exemplary embodiments 501A-501F where each aircraft has an aspect ratio of two, a total wing area of 435 in² per wing, a wing sweep angle of 35°, an angle of attack of 2°, and a coefficient profile drag of 0.0069. Once each of the exemplary six lift to drag ratios is determined for exemplary embodiments 501A-501F with an aspect ratio of two, they may be plotted and a first best-fit trend line 601 may be inserted. The lift to drag ratio may also be plotted where each of exemplary embodiments 501A-501F has an aspect ratio of four but are otherwise the same as above. Once each of the six lift to drag ratios is determined for exemplary embodiments 501A-501F with an aspect ratio of four, they may be plotted and a second best-fit trend line 602 may be inserted. As best-fit trend lines 601, 602 illustrate, as the wing separation increases, the lift to drag ratio increases logarithmically. The similarities between best-fit trend lines 601, 602 also illustrate that an aircraft's efficiency due to wing separation is decoupled from the aircraft's aspect ratio.

An exemplary vehicle's wing separation may be selected to meet a variety of design criteria. For example, a wing separation of 30 in. may increase the performance of an exemplary aircraft by 18.5%, less than a small change in the aspect ratio. In contrast, a separation of 15 in. may increase the performance of the aircraft by 7% as well as may produce a structurally sound aircraft.

### Wing Stagger

According to some exemplary embodiments, an aircraft's wings may be staggered. Stagger may refer to the placement of the leading edge of a first wing in relation to the location of the leading edge of a second wing of an aircraft. Positive stagger may refer to the placement of the leading edge of a first wing forward of the leading edge of the second wing. Negative stagger may refer to the placement of the leading edge of the first wing behind the leading edge of the second wing. An aircraft's stagger may impact the aircraft's efficiency and/or flying characteristics.

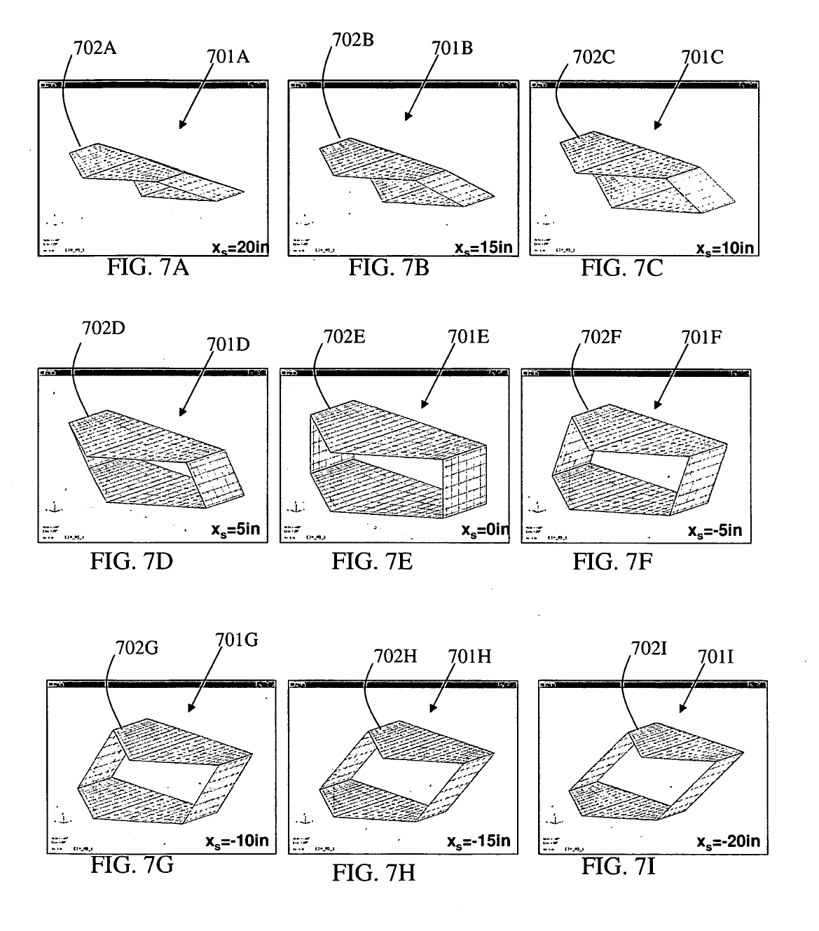

FIGS. 7A-71 depict nine exemplary embodiments 701A-701I of the aircraft 10 with nine exemplary wing stagger amounts ranging from 20 in. to −20 in. Exemplary embodiments 701A-701I may have equal wing areas, equal wing separation, and a constant wing sweep angle of 35°.

FIG. 7A depicts exemplary embodiment 701A with a wing stagger 702A of 20 in.

FIG. 7B depicts exemplary embodiment 701B with a wing stagger 702B of 15 in.

FIG. 7C depicts exemplary embodiment 701C with a wing stagger 702C of 10 in.

FIG. 7D depicts exemplary embodiment 701D with a wing stagger 702D of 5 in.

FIG. 7E depicts exemplary embodiment 701E with a wing stagger 702E of 0 in.

FIG. 7F depicts exemplary embodiment 701F with a wing stagger 702F of −5 in.

FIG. 7G depicts exemplary embodiment 701G with a wing stagger 702G of −10 in.

FIG. 7H depicts exemplary embodiment 701H with a wing stagger 702H of −15 in.

FIG. 71 depicts exemplary embodiment 7011 with a wing stagger 7021 of −20 in.

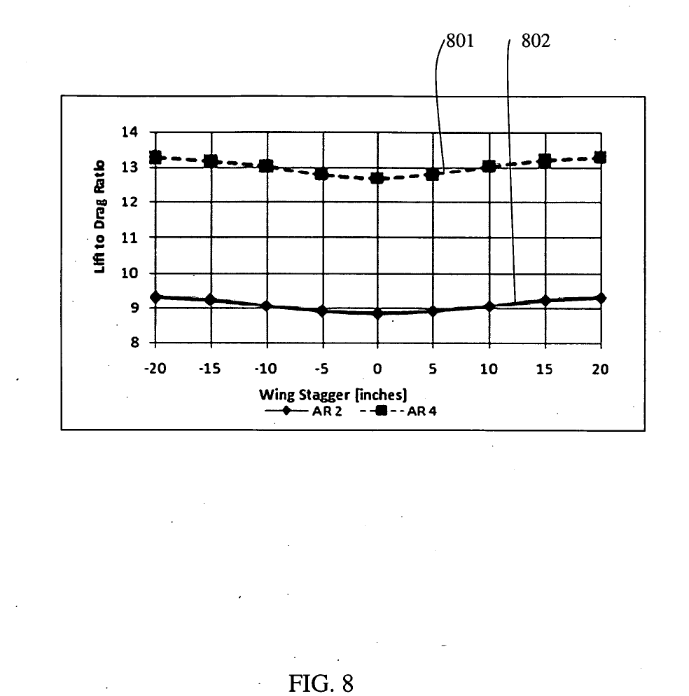

FIG. 8 depicts the lift to drag ratio as a function of wing stagger for exemplary embodiments 701A-701I. Using AVL, the lift to drag ratio may be plotted for each of the exemplary embodiments 701A-701I where each exemplary embodiment has an aspect ratio of two, a total wing area of 435 in² per wing, a wing sweep angle of 35°, an angle of attack of 2°, and a coefficient profile drag of 0.0069. Once each of the nine lift to drag ratios has been plotted, for exemplary embodiments 701A-701I with an aspect ratio of two, a best-fit trend line 801 may be inserted. The lift to drag ratio may also be plotted where each of the exemplary embodiments 701A-701I has an aspect ratio of four but are otherwise the same as above. Once each of the lift to drag ratios has been plotted, for exemplary embodiments 701A-701I with an aspect ratio of four, a second best-fit trend line 802 may be inserted. As both of the best-fit trend lines 801, 802 illustrate, the lift to drag ratio increases logarithmically with either positive or negative wing stagger. The similarities between best-fit trend lines 801, 802 also illustrate that an aircraft's efficiency due to wing stagger is decoupled from the aircraft's aspect ratio.

An exemplary vehicle's wing stagger may be selected to meet a variety of design criteria. For example, the increase in aerodynamic efficiency due to stagger is relatively low when compared to aspect ratio or wing separation. At a stagger of 20 in. there is only a 5.5% increase in the lift to drag ratio compared to a stagger of 10% where there is a 2.5% increase in the lift to drag ratio. However, positive stagger may induce a longitudinally stabilizing side effect. Because of the induced velocity by each wing, a positive stagger may force the front wing to stall first. When the leading wing stalls first, the neutral point may shift rearward which may cause the plane to become more stable. Therefore, a small positive stagger of approximately 5 in. may be recommended due to its stabilizing effects.

### Wing Area Distribution

According to some exemplary embodiments, an area of the first wing and the second wing of an aircraft wing may be uneven. When the area of the first wing and/or the second wing is increased or decreased, while keeping the wing's span constant, the wing's aspect ratio may change. A wing's aspect ratio may refer to the ratio of the wing's span, which may remain constant, to the wing's mean aerodynamic chord. As an individual wing's area increases/decreases, the mean aerodynamic chord increases/decreases and the wing's aspect ratio decreases/increases accordingly. An uneven wing area between the first wing and the second wing may impact the aircraft's efficiency and/or flying characteristics.

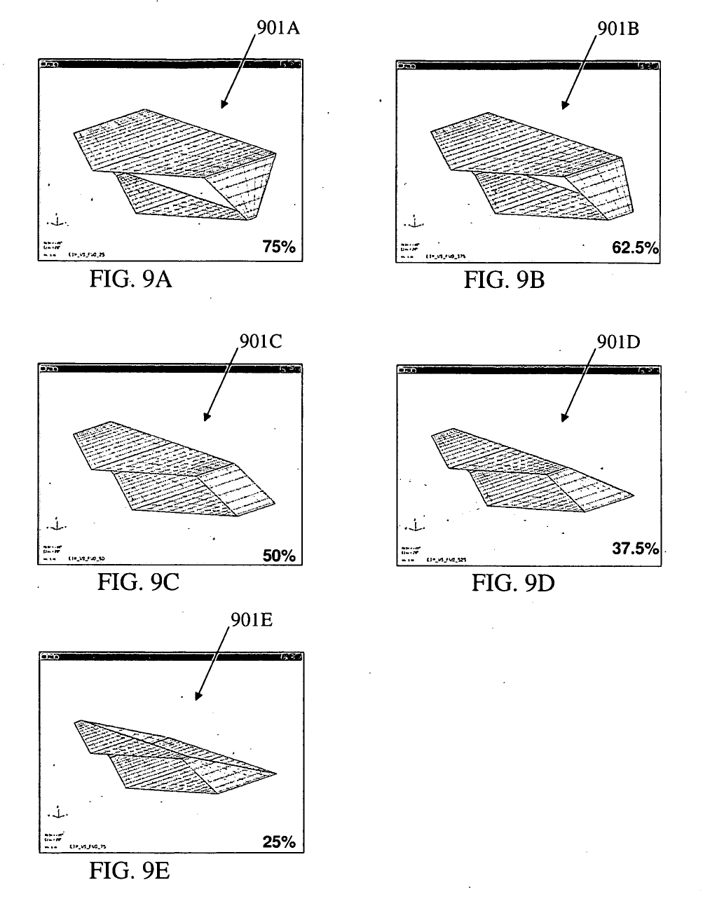

FIGS. 9A-9E depict five exemplary embodiments 901A-901E of the aircraft 10 with exemplary wing area distributions and an exemplary positive stagger. Exemplary embodiments 901A-901E may have a constant average aspect ratio of 2, a constant wing separation of 10 in., and 10 in. positive wing stagger.

FIG. 9A depicts an exemplary embodiment 901A with a 75% ratio of first-wing area to second-wing area.

FIG. 9B depicts an exemplary embodiment 901B with a 62.5% ratio of first-wing area to second-wing area.

FIG. 9C depicts an exemplary embodiment 901C with a 50% ratio of first-wing area to second-wing area.

FIG. 9D depicts an exemplary embodiment 901D with a 37.5% ratio of first-wing area to second-wing area.

FIG. 9E depicts an exemplary embodiment 901E with a 25% ratio of first-wing area to second-wing area.

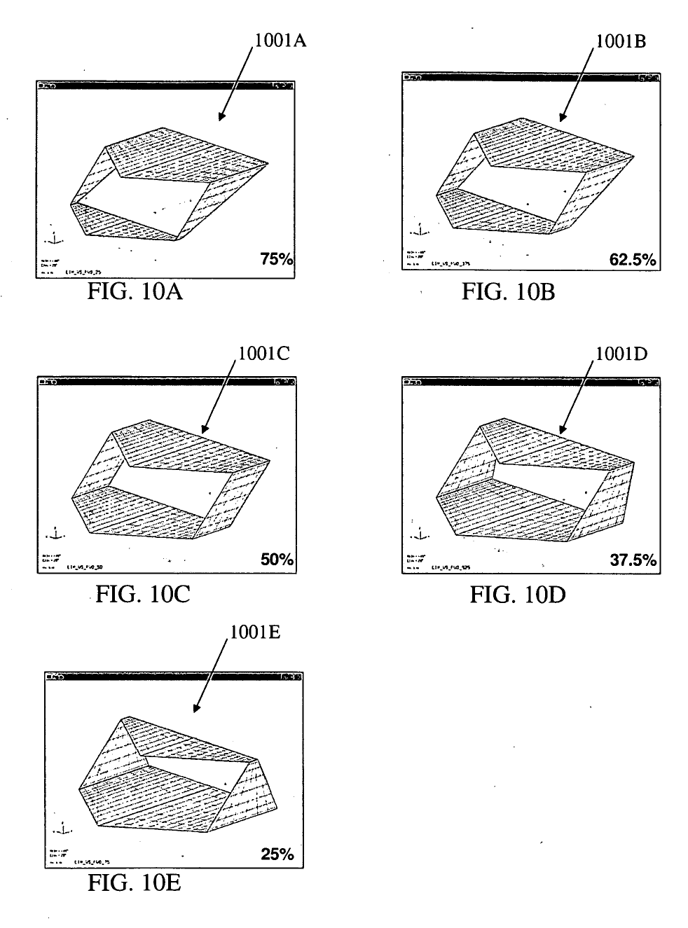

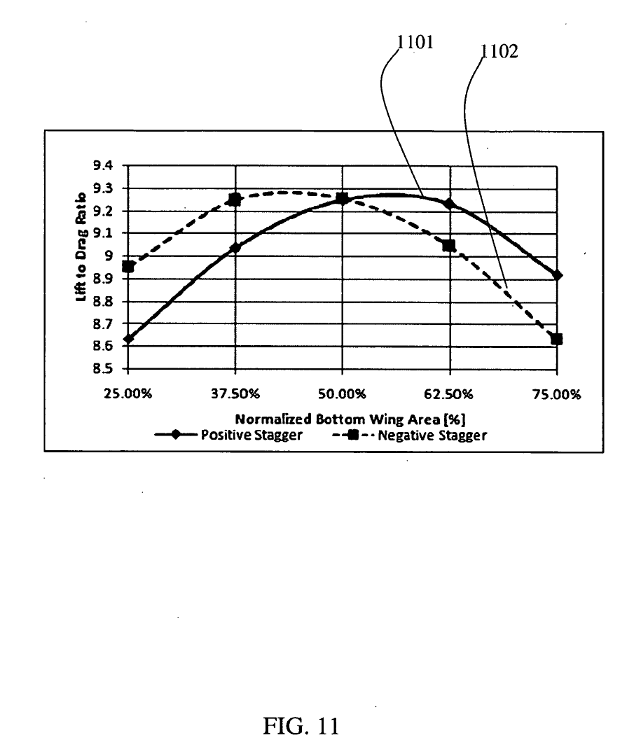

FIGS. 10A-10E depict five exemplary embodiments 1001A-1001E of the aircraft with exemplary wing area distributions and an exemplary negative stagger. Exemplary embodiments 1001A-1001E may have a constant average aspect ratio of 2, a constant wing separation of 10 in., and 10 in. negative wing stagger.

FIG. 10A depicts an exemplary embodiment 1001A with a 75% ratio of first-wing area to second-wing area.

FIG. 10B depicts an exemplary embodiment 1001B with a 62.5% ratio of first-wing area to second-wing area.

FIG. 10C depicts an exemplary embodiment 1001C with a 50% ratio of first-wing area to second-wing area.

FIG. 10D depicts an exemplary embodiment 1001D with a 37.5% ratio of first-wing area to second-wing area.

FIG. 10E depicts an exemplary embodiment 1001E with a 25% ratio of first-wing area to second-wing area.

FIG. 11 depicts the lift to drag ratio as a function of the positive or negative wing stagger for exemplary embodiments 901A-901E and 1001A-1001E. Using AVL, the lift to drag ratio may be plotted for each exemplary embodiments 901A-901E where each aircraft may have a constant average aspect ratio of two, a wing sweep angle of 35°, a constant wing separation of 10 in., a 10 in. positive wing stagger, an angle of attack of 2°, and a coefficient profile drag of 0.0069. Once each of the five lift to drag ratios have been plotted for exemplary embodiments 901A-901E a best-fit trend line 1101 may be inserted. Using AVL, the lift to drag ratio may be plotted for each exemplary embodiments 1001A-1001E where each aircraft may have a constant average aspect ratio of two, a wing sweep angle of 35°, a constant wing separation of 10 in., a 10 in. negative wing stagger, an angle of attack of 2°, and a coefficient profile drag of 0.0069. Once each of the five lift to drag ratios have been plotted for exemplary embodiments 1001A-1001E a best-fit trend line 1102 may be inserted.

As both of the best-fit trend lines 1101, 1102 illustrate the first wing may have a slightly larger or equal wing area for optimum aerodynamic performance, and to maximize the overlapping wing area for potential payloads. However, as the differential distribution of the wing area increases, the wing stagger and aerodynamic efficiency also may increase. Since the relationship of the aspect ratio and aerodynamic performance are the most sensitive, the optimum design may have approximately equal wing area distributions.

### Airfoil Selection

According to some embodiments, exemplary embodiments of the aircraft may comprise reflexed or non-reflexed air foils. A reflexed air foil may refer to an airfoil having a convex camber over part of an airfoil's chord length and a concave reflex along the trailing edge. The convex camber may create a pitch down movement. The concave ‘reflex’ may help neutralize the pitch down movement created by the airfoil's convex chamber. An exemplary reflexed airfoil may have a convex camber for approximately 70-90% of the chord.

A non-reflexed airfoil may refer to an airfoil that has a convex chamber over part of an airfoil's chord length but does not have a concave reflex along the trailing edge. Since non-reflexed airfoils do not have a concave reflex, they may have a pitch down movement. In order to counteract this pitch down movement, an exemplary embodiment may contain a counter pitch up movement. Counter pitch up movements can be created by incorporating control surfaces into the exemplary embodiment's design and/or adjusting the angle of incidence of the propulsion mechanism, both of which are discussed below.

According to some exemplary embodiments, exemplary embodiments of the aircraft's upper and lower wings may be selected from one of three categories of non-reflexed airfoils. Airfoils may be categorized based on their camber. A low camber group may contain airfoils with less than 2% camber. A medium camber group may contain airfoils with a camber between 2-4%. A high camber group may contain airfoils with a camber of more than 4%.

According to some exemplary embodiments, the aircraft may operate at low Reynolds numbers based on the spanwise location and angle of attack. An exemplary range of Reynolds numbers may be approximately 500,000 and 150,000. For each category, the polar curves for each airfoil may be computed using a computer at the average Reynolds number of 300,000.

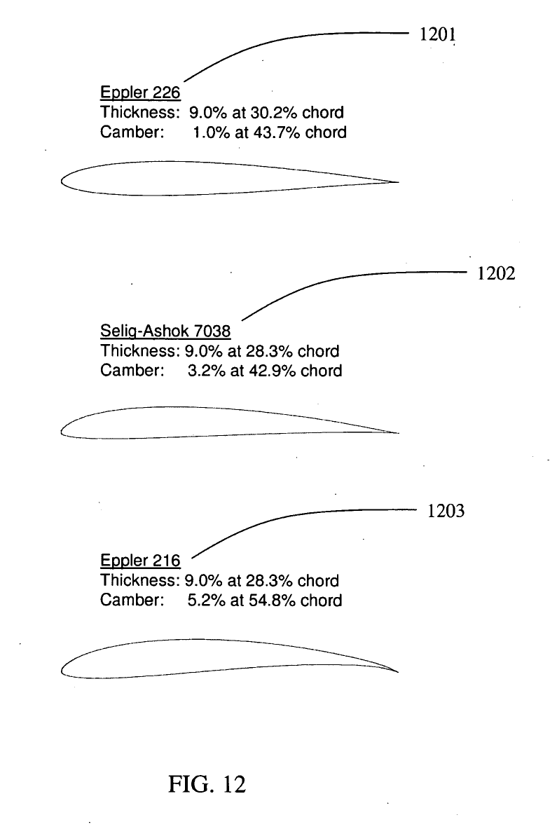

FIG. 12 depicts an exemplary airfoil from the low camber group, the “Eppler 226” 1201, the medium camber group, “Selig-Ashol 7038” 1202, and the high camber group, “Eppler 216” 1203. All three exemplary airfoils may be specifically designed for relatively low Reynolds numbers.

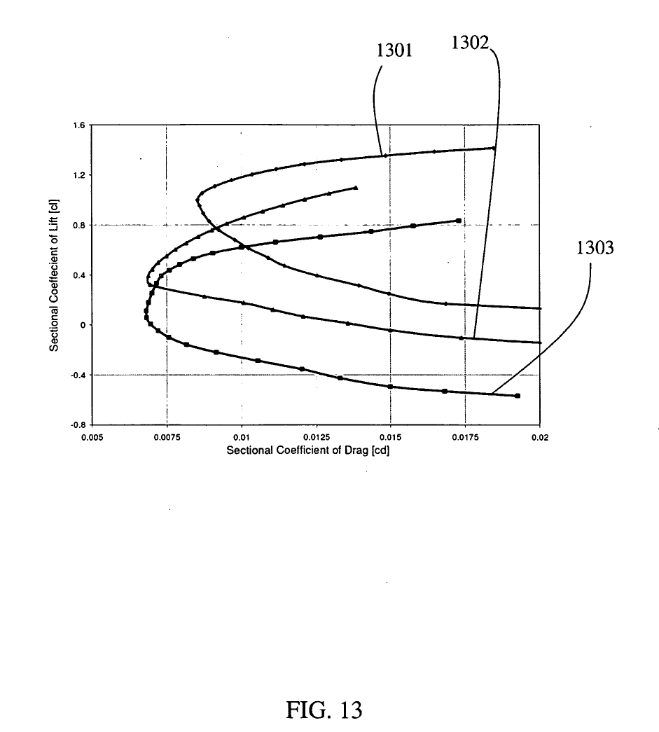

FIG. 13 depicts exemplary polar curves for the “Eppler 226” airfoil 1301, the “Selig-Ashol 7038” airfoil 1302, and the “Eppler 216” airfoil 1303. of the three best airfoils from each of the categories. The exemplary polar curves for each airfoil were computed using a computer at the average Reynolds number of 300,000.

An exemplary airfoil may be selected to meet a variety of design criteria. For example, a high coefficient of lift and low coefficient of friction may help reduce flight speed. Exemplary “Selig-Ashol 7038” airfoil 1302, which has a medium camber, has a high coefficient of lift and a coefficient of drag only slightly larger than an airfoil with a low camber. Additionally an airfoil with a semi-flat bottom may also be desired. In contrast, high camber airfoils may have a higher coefficient of lift, but they may also have a much larger coefficient of drag. Based on these factors a medium camber airfoil may be used in an exemplary embodiment. Additionally, since the Reynolds number greatly varies along the span, it may be advantageous to choose different airfoils for the root and tip of the wing.

Finally, a NACA 0009 symmetric airfoil may be chosen for the wing joiners. Potentially a cambered airfoil can be chosen for the wing joiners to increase the aerodynamic efficiency.

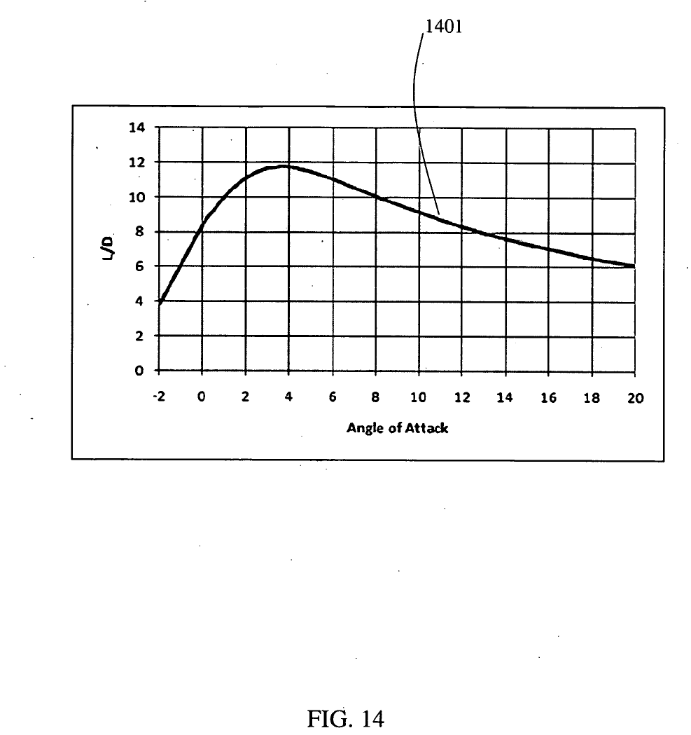

FIG. 14 depicts the lift to drag ratio as a function of angle of attack for an exemplary embodiment whose upper and second wings use a “Selig-Ashol 7038” airfoil. Using a computer analysis, and assuming a total aircraft weight of 42 oz., the lift to drag ratio may be plotted at a variety of angles of attack. Once each of the resulting lift to drag ratios has been plotted, a best-fit trend line 1401 may be inserted. As the trend line 1401 illustrates, the optimum angle of attack for the exemplary aircraft is approximately 4° (L/D˜12), and over the majority angle of attacks the lift to drag ratio is above 8. Only at high angle of attack (approaching stall) will the lift to drag drop below 8.

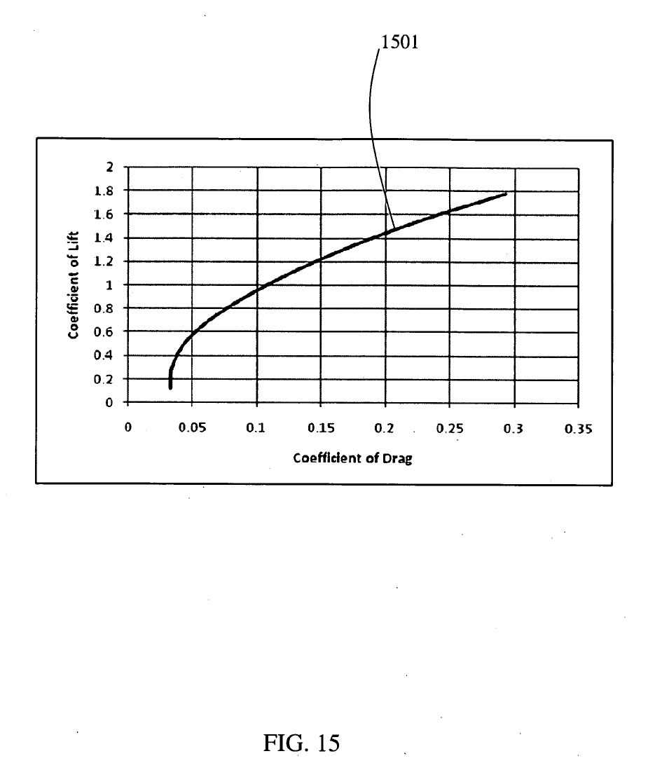

FIG. 15 depicts an exemplary embodiment of a global aircraft polar curve.

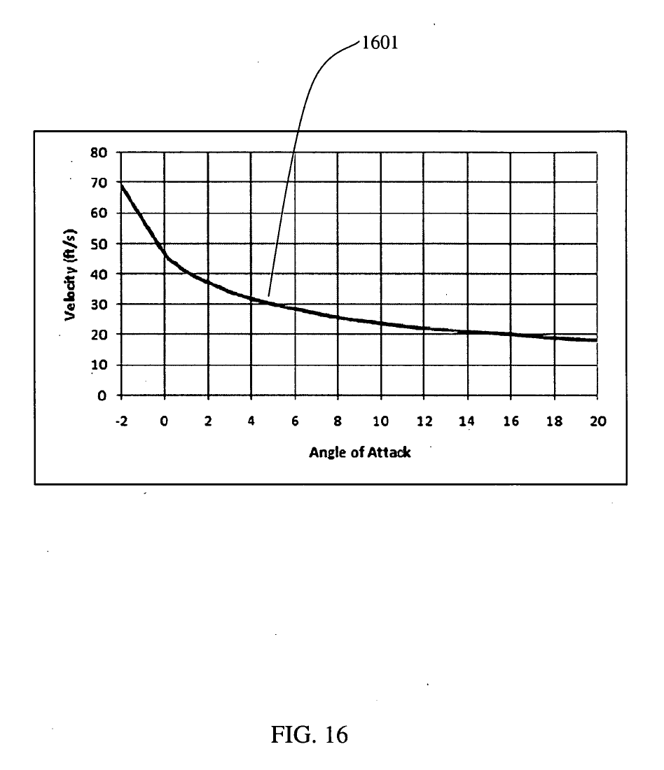

FIG. 16 depicts the flight speed as a function of angle of attack for an exemplary embodiment of the aircraft whose first and second wings use a “Selig-Ashol 7038” airfoil. Using a computer analysis, and assuming a total aircraft weight of 42 oz., flight speed may be plotted for a variety of angles of attack. Once each of the resulting flight speeds have been plotted, a best-fit trend line 1601 may be inserted. As the trend line 1601 illustrates, as the angle of attack increases so does the coefficient of lift. Therefore, as the angle of attack increases, the steady level flight speed decreases. According to the trend line 1601, the optimum angle of attack (4°), as determined in connection with FIG. 14, results in a steady level flight speed of approximately 30 ft/s (20.5 mph). As the angle of attack approaches stall, approximately 16°, a steady level flight speed of approximately 20 ft/s (13.5 mph) may result.

### Exemplary Propulsion Mechanisms

Exemplary embodiments of the aircraft 10 may contain a propulsion mechanism including, e.g., but not limited to, a fuel source, a power source, a power storage device, and/or an energy storage device, etc. According to some embodiments, a fuel source, a power source, a fuel cell, a power storage device, and/or an energy storage device may include, e.g., but not limited to, fuel, a compressed gas, a fluid, electric energy, hydrogen, conventional fossil fuels, jet fuel, etc.

In exemplary embodiments of the aircraft 10, the fuel source, power source, power storage device, and/or energy storage device may be coupled to, e.g., but not limited to, an engine and/or motor.

According to some embodiments, a motor may include, but is not necessarily limited to, an electric motor. The electric motor may be powered by, for example, a power supply, such as, e.g., but not limited to, a battery, a hydrogen fuel cell, and/or a solar cell. According to some embodiments, an engine may include, but is not necessarily limited to, an internal combustion engine. An engine may be powered by, e.g., but not limited to, a fossil fuel, a hydrogen fuel cell, etc.

According to some exemplary embodiments, when a rotating motor is used in the propulsion mechanism, a roll moment may be created due to frictional force, induced velocity over the wing, and/or the p-factor. While it may be extremely difficult to accurately account for these factors, a small degree of right shim, for example, but not limited to, 2°, etc., may compensate for the roll moment.

In an exemplary embodiment, the fuel source, power source, power storage device, and/or energy storage device, and/or the engine and/or motor may be coupled to, e.g., but not limited to a propeller, a turbine, a reaction engine, a jet, a rocket, and/or a turbo-prop to generate thrust.

In an exemplary embodiment, the propeller may be rearward facing or forward facing, etc.

Other exemplary embodiments of a propulsion mechanism may include any source of thrust, such as, e.g., a biological propulsion system, a rocket, a jet, a turbo jet, etc.

In an exemplary embodiment, an exemplary propulsion mechanism may be detachable either before, during and/or after a flight.

An exemplary aircraft's propulsion mechanism may be selected to meet a variety of design criteria. For example, a propulsion mechanism may be selected based on the aircraft's total mass, the aircraft's desired flying time, the aircraft's desired flying speed, the aircraft's desired payload, the propulsion mechanism's weight, the propulsion mechanism's efficiency, and/or the propulsion mechanism's power.

### Control Surface Sizing

According to some exemplary embodiments, the aircraft may have one or more control surfaces. Control surfaces may include, e.g., but are not necessarily limited to, ailerons, rudders, elevators, and/or flaps. Control surfaces may be located in and/or on an exemplary aircrafts first wing, second wing, and/or a wing joiner. The location of control surfaces may impact the aircraft's efficiency and/or flying characteristics.

The type and placement of control surfaces on an exemplary embodiment may be influenced by several factors, each of which may cause a pitch up or a pitch down movement. Examples of the factors may include, e.g., but are not limited to, the use of a non-reflexive airfoil, the location of the exemplary embodiment's center of gravity, and/or the location of the propulsion mechanism.

To determine the location center of gravity, an exemplary embodiment may be determined from the exemplary embodiment's neutral point, percent static margin, and/or mean chord. The aircraft's neutral point may be determined using AVL. The percent static margin may be estimated based on the type of aircraft. The mean chord may be measured. The center of gravity, x_{cg}, may equal:

x_{cg}=xₙₚ− c̅%SM (1)

where xₙₚ is the neutral point, c is the mean chord length, and % SM is the percent static margin. For an exemplary embodiment, where the neutral point is 10.8 in. behind the leading point of the first wing, the static margin is estimated to be 5-10%, and the mean chord is 15.25 in., the center of gravity would be between 9.25 in. and 10 in. behind the leading edge of the first wing.

Pitch up and/or pitch down movements caused by the above exemplary factors may be negated by causing an opposing pitch movement. An opposing pitch movement may be caused in several ways including, e.g., but not limited to, properly positioning control surfaces and/or adjusting the propulsion mechanisms such that the thrust line passes through or below the exemplary embodiment's center of gravity.

In an exemplary embodiment, a static elevator may be positioned on or in either the second wing or the first wing in order to counteract the airfoil's pitching moments and balance the aircraft during steady flight. Dynamic elevators may be positioned in the other wing for active airplane control. Additionally, the dynamic elevator deflection may be limited to prevent extreme flow separation and/or control surface stall.

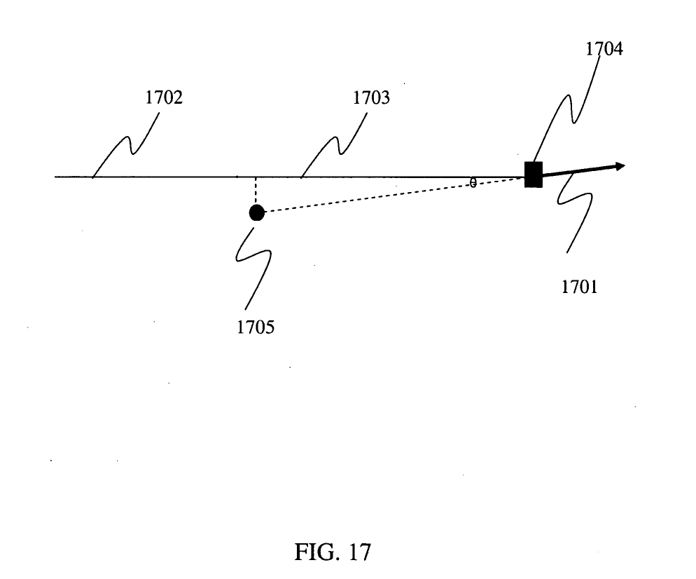

FIG. 17 shows an exemplary static determination of the thrust line 1701 for the exemplary embodiment. Note that the center of gravity 1705 is approximately located 10.8 in. behind the leading edge 1702 of the first wing 1703 and 1 in. below the motor. Using this geometry the thrust angle may be determined to be approximately 5°.

According to some exemplary embodiments, when a rotating motor is used in the propulsion mechanism, a roll moment may be created due to frictional force, induced velocity over the wing, and/or the p-factor. While it may be extremely difficult to accurately account for these factors, 2° of right shim may initially be applied.

### Payload

According to some exemplary embodiments, the aircraft or air vehicle may carry a payload. The size and weight of exemplary payloads may depend on the size of an exemplary aircraft and/or the amount of weight the aircraft can carry. Exemplary payloads may include, e.g., but are not necessarily limited to, one or more sensors. A sensor may refer to, e.g., but may not necessarily be limited to, a thermal sensor, an electromagnetic sensor, a mechanical sensor, a chemical sensor, an optical radiation sensor, an ionizing radiation sensor, an acoustic sensor, a positional sensor (e.g., but not limited to, a Global Positioning System enabled sensor), and/or an altitude sensor.

### Conclusion

The embodiments illustrated and discussed in this specification are intended only to teach those skilled in the art the best way known to the inventors to make and use the invention. Nothing in this specification should be considered as limiting the scope of the present invention. All examples presented are representative, exemplary and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A bi-plane air vehicle comprising:
a plurality of wings coupled to one another in substantially a box configuration, wherein the bi-plane air vehicle has no tail.

2. The air vehicle of claim 1, further comprising:
at least one propulsion mechanism disposed on the air vehicle.

3. The air vehicle of claim 2, wherein the propulsion mechanism comprises:
at least one motor coupled to, and operable to rotate a propeller; and
at least one power source coupled to the motor to energize the motor.

4. The air vehicle according to claim 3, wherein the propeller is at least one of rearward or forward facing.

5. The air vehicle according to claim 2, wherein the propulsion mechanism further comprises a power source compring at least one of:
a hydrogen fuel cell;
a fossil fuel;
a rechargeable battery;
a battery;
a fuel cell;
a power supply; or
a solar cell.

6. The air vehicle of claim 2, wherein the propulsion mechanism comprises at least one of:
a propeller coupled to a motor;
a propeller coupled to a gas motor;
a propeller coupled to an electric motor;
a propeller coupled to a motor powered by solar energy;
a propeller coupled to a motor powered by a hydrogen fuel source;
a propeller coupled to a motor powered by a fuel cell;
a jet;
a turboprop; or
a rocket.

7. The air vehicle according to claim 3, wherein the motor is an electric motor.

8. The air vehicle according to claim 3, wherein the motor is an engine.

9. The air vehicle according to claim 1, wherein the air vehicle comprises at least one of:
a manned air vehicle;
an airplane;
an unmanned air vehicle (UAV);
a mini-UAV; or
a micro-UAV.

10. The air vehicle according to claim 1, wherein the air vehicle comprises a manned air vehicle.

11. The air vehicle according to claim 1, wherein said plurality of wings comprise at least one of:
a wing;
a delta-wing;
a swept wing;
a cranked arrow wing; or
a straight wing.

12. The air vehicle according to claim 1, wherein a first of said plurality of wings is disposed forward of a second of said plurality of wings.

13. The air vehicle of claim 1, wherein a first of said plurality of wings comprises a first wing shape and a second of said plurality of wings comprises a second wing shape.

14. The air vehicle of claim 1, wherein a first of said plurality of wings comprises a cranked arrow wing shape and a second of said plurality of wings comprises a delta wing shape.

15. The air vehicle according to claim 1, wherein a first and a second of said plurality of wings comprise delta wing shapes.

16. The air vehicle according to claim 1, further comprising a wireless communication link for remote control of the air vehicle.

17. The air vehicle according to claim 17, wherein said wireless communication link comprises at least one of:
an infrared (IR) link;
a line-of-sight link;
a radio-frequency (RF) communication link; or
a laser link.

18. The air vehicle according to claim 1, further comprising an assisted take off system.

19. The air vehicle according to claim 1, further comprising a landing device.

20. The air vehicle according to claim 1, further comprising a payload.

21. The air vehicle according to claim 21, wherein said payload comprises a sensor, wherein the sensor comprises at least one:
a thermal sensor;
an electromagnetic sensor;
a mechanical sensor;
a chemical sensor;
an optical radiation sensor;
an ionizing radiation sensor;
an acoustic sensor;
a positional sensor; or
an altitude sensor.

22. The air vehicle according to claim 1, wherein said plurality of wings comprise a pair and wherein a first of said pair of wings extends further in front of a second of said pair of wings.

23. The air vehicle according to claim 1, further comprising a middle wing joiner to increase structural strength of the vehicle.

24. The air vehicle according to claim 1, wherein said plurality of wings are constructed from at least one of the following:
foam;
aluminum;
metal;
plastic;
polymer; or
wood.

25. The air vehicle according to claim 1, wherein said plurality of wings are coupled together by at least one wing joiner.

26. The air vehicle according to claim 26, wherein said plurality of wings are coupled together by a pair of wing joiners at the extremities of each wing forming said box configuration, wherein said box configuration comprises substantially orthogonal corners when viewed from at least one of a front, or a back of the air vehicle.

27. The air vehicle according to claim 26, wherein said plurality of wings are coupled together by a pair of wing joiners at the extremities of each wing forming said box configuration, wherein said box configuration comprises rounded corners when viewed from at least one of a front, or a back of the air vehicle.
